(19) United States
(12) Patent Application Publication
(10) Pub. No.: US 2018/0058321 A1
(43) Pub. Date: Mar. 1, 2018

(54) PLANT CONTROL APPARATUS, PLANT CONTROL METHOD AND POWER PLANT

(71) Applicant: KABUSHIKI KAISHA TOSHIBA, Minato-ku (JP)

(72) Inventors: Kumiko YOKOYAMA, Yokohama (JP); Masayuki TOBO, Kawasaki (JP); Kazuna SAWATA, Yokohama (JP)

(73) Assignee: KABUSHIKI KAISHA TOSHIBA, Minato-ku (JP)

(21) Appl. No.: 15/666,899

(22) Filed: Aug. 2, 2017

(30) Foreign Application Priority Data
Aug. 29, 2016 (JP) 2016-167033

(51) Int. Cl. F02C 6/18; F02C 3/04; F01K 23/10; F02C 9/00; F01K 7/16

(52) U.S. Cl. CPC F02C 6/18; F02C 3/04; F01K 23/10; F02C 9/00; F05D 2240/35; F05D 2220/72; F05D 2220/32; F05D 2270/05; F01K 7/16

(57) ABSTRACT

In one embodiment, a plant control apparatus controls a power plant including a combustor configured to burn fuel to generate a combustion gas, a gas turbine driven by the combustion gas from the combustor, a heat recovery steam generator configured to use heat of an exhaust gas from the gas turbine to generate steam, and a steam turbine driven by the steam from the heat recovery steam generator. The apparatus includes a gas turbine controller configured to control an output value of the gas turbine to a second output value that is larger than a first output value and depends on atmospheric temperature and then control the output value of the gas turbine to the first output value. The apparatus further includes a steam turbine controller configured to start up the steam turbine while the output value of the gas turbine is controlled to the first output value.

### CROSS REFERENCE TO RELATED APPLICATION

This application is based upon and claims the benefit of priority from the prior Japanese Patent Application No. 2016-167033, filed on Aug. 29, 2016, the entire contents of which are incorporated herein by reference.

### FIELD

Embodiments described herein relate to a plant control apparatus, a plant control method and a power plant.

### BACKGROUND

In general, a combined-cycle power plant includes a gas turbine, a heat recovery steam generator, and a steam turbine. Specifically, a combustor burns fuel with air from a compressor, and then the gas turbine is driven by a combustion gas supplied from the combustor. The heat recovery steam generator generates steam using the heat of an exhaust gas discharged from the gas turbine. The steam turbine is driven by the steam (main steam) supplied from the heat recovery steam generator.

The combined-cycle power plant is started up in the following manner. First, the heat recovery steam generator is caused to fire, with a gas turbine output set at a second output value, which is a large value, so that a main steam temperature is caused to rise quickly. Next, when the main steam temperature rises to a temperature that is suitable to startup of the steam turbine, the gas turbine output is switched to a first output value, which is a small value. This can shorten the starting time of the power plant.

The first output value is an output value for adjusting an exhaust gas temperature to a predetermined temperature, based on a metal temperature of a first stage inner surface of the steam turbine. If the gas turbine output is kept at the second output value, the main steam temperature considerably exceeds the metal temperature of the first stage inner surface. Such a main steam temperature is unsuitable for the startup of the steam turbine. Therefore, the gas turbine output is switched from the second output value to the first output value. This decreases the exhaust gas temperature, thereby making it possible to obtain the main steam temperature suitable for the startup of the steam turbine.

### BRIEF DESCRIPTION OF THE DRAWINGS

FIG. 1 is a schematic diagram illustrating a configuration of a power plant in a first embodiment;

FIG. 2 is a cross-sectional view illustrating a structure of a steam turbine in the first embodiment;

FIG. 3 is a flowchart illustrating a plant control method in the first embodiment;

FIG. 4 is a graph for illustrating the plant control method in the first embodiment;

FIG. 5 is a graph for illustrating a plant control method in a comparative example of the first embodiment;

FIG. 6 is a graph for illustrating a plant control method in a modification of the first embodiment;

FIG. 7A to 7C are graphs illustrating exhaust gas temperature characteristics of a conventional gas turbine; and

FIG. 8A to 8C are graphs illustrating exhaust gas temperature characteristics of the latest model of gas turbine.

### DETAILED DESCRIPTION

Embodiments will now be explained with reference to the accompanying drawings.

Since the second output value is an output value for quickly increasing the main steam temperature, the second output value is desirably made as large as possible. From a same reason, to cause the main steam temperature to rise quickly, the exhaust gas temperature at the time when a gas turbine output takes on the second output value is desirably made as high as possible. In a conventional gas turbine, as the second output value, for example, a maximum gas turbine output that provides an exhaust gas temperature not exceeding a maximum operating temperature (T_{MAX}) of a heat exchanger constituting a heat recovery steam generator.

However, an operation state that the steam turbine has not been subjected to steam injection although a gas turbine is in light-off operation is in some sense a particular state. Therefore, if the second output value (or the exhaust gas temperature at the time when the gas turbine output takes on the second output value) exceeds a proper value and increases, some problems arise.

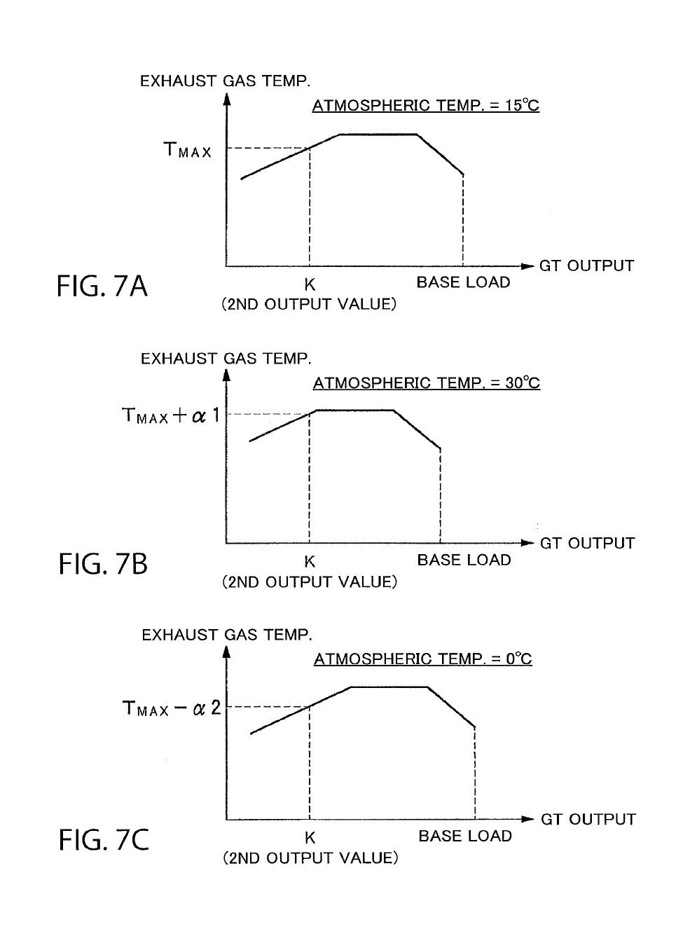

FIG. 7A to 7C are graphs illustrating exhaust gas temperature characteristics of a conventional gas turbine. Each graph illustrates a relation between gas turbine output (GT output) and exhaust gas temperature.

FIG. 7A is a graph at the time when an atmospheric temperature is 15° C., and 15° C. is a typical atmospheric temperature of spring and fall. The atmospheric temperature is an air temperature of a vicinity of an air inlet of a compressor (a same applies hereinafter). This graph illustrates a second output value K and the maximum operating temperature T_{MAX}. The second output value K is a gas turbine output with which the exhaust gas temperature becomes the maximum operating temperature T_{MAX} when the atmospheric temperature is 15° C.

In general, when the atmospheric temperature rises, a temperature of air taken in by the compressor rises, an inlet temperature of the gas turbine (a combustion temperature) also rises, so that the exhaust gas temperature characteristics of the gas turbine change. Therefore, FIG. 7A to FIG. 7C illustrates the exhaust gas temperature characteristics of the gas turbine with the atmospheric temperature specified. As seen from these graphs, even when the gas turbine output takes on a same value, the exhaust gas temperature rises as the atmospheric temperature rises, and a curve representing the exhaust gas temperature characteristics shifts leftward.

FIG. 7B is a graph at the time when the atmospheric temperature is 30° C., and 30° C. is a typical atmospheric temperature of summer. In this case, when the gas turbine operates at the second output value K, the exhaust gas temperature becomes T_{MAX}+α1 (α1 is a positive value), which is higher than T_{MAX}. Therefore, the exhaust gas temperature deviates from T_{MAX} by α1, and a deviation amount α1 of this case is small (in comparison with a deviation amount α3 of a latest model of gas turbine, which will be described later). For this reason, setting the second output value at a value slightly smaller than K, rather than K, with consideration given to this deviation amount α1 causes no practical problems.

FIG. 7C is a graph at the time when the atmospheric temperature is 0° C., and 0° C. is a typical atmospheric temperature of winter. In this case, when the gas turbine operates at the second output value K, the exhaust gas temperature becomes T_{MAX}−α2 (α2 is a positive value), which is lower than T_{MAX}. While a curve representing the exhaust gas temperature characteristics for an atmospheric temperature of 15° C. shifts leftward when the atmospheric temperature is 30° C., the curve for an atmospheric temperature of 15° C. shifts rightward when the atmospheric temperature is 0° C.

The reason for specifying the second output value K as the gas turbine output with which the exhaust gas temperature becomes T_{MAX} when the atmospheric temperature is 15° C. is that 15° C. is approximate to an average annual temperature, and the gas turbine operates at about 15° C. with high frequency.

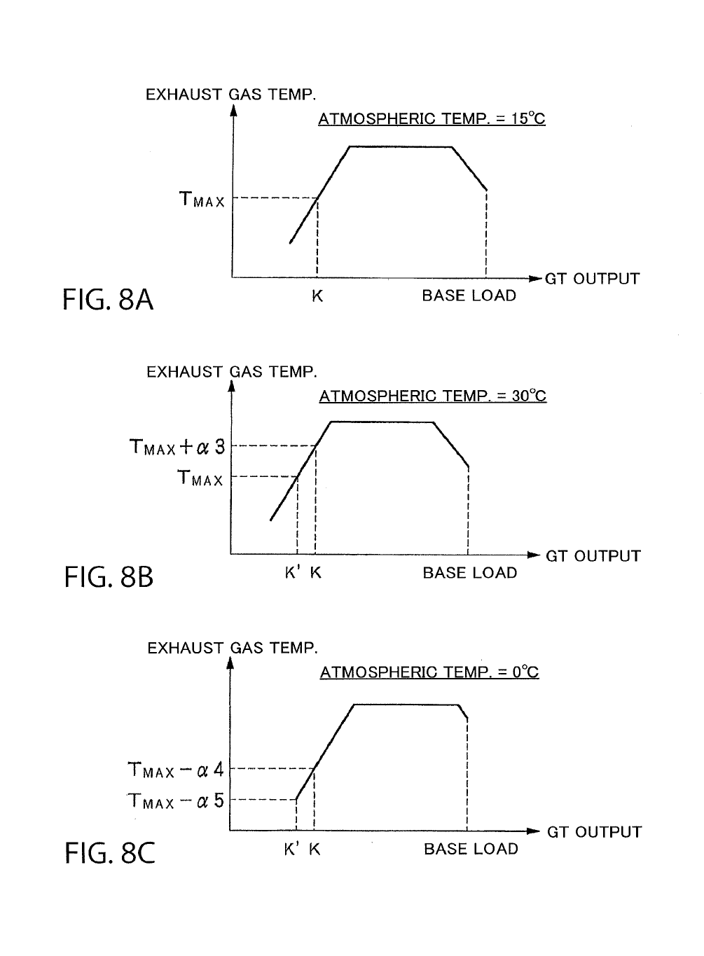

FIG. 8A to 8C are graphs illustrating exhaust gas temperature characteristics of the latest model of gas turbine.

FIG. 8A is a graph at the time when an atmospheric temperature is 15° C. As is clear from FIG. 8A and the other drawings, in the latest model of gas turbine, the atmospheric temperature has an influence on the exhaust gas temperature characteristics to a great extent. As a result, how to choose the second output value K is difficult.

Factors behind the adoption of such exhaust gas temperature characteristics include a fact that power plants are nowadays economy-oriented and environmental-protection oriented. Due to such orientations, a performance of the latest model of gas turbine is significantly increased with an increase in inlet temperature of a turbine (a combustion temperature), so that an exhaust gas temperature also reaches high temperatures in comparison with the conventional gas turbine.

Additionally, the latest model of gas turbine operates so that the exhaust gas temperature reaches high temperatures not only in middle and high output regions but also in a low output region. The reason for this is to design a premix combustion from the low output region (=a start of low NO_{X} combustion) with enhancement of a thermal efficiency of the plant in a partial load region.

FIG. 8A illustrates the second output value K and the maximum operating temperature T_{MAX}. It can be seen that an inclination of a continuously increasing linear graph in a low output region of FIG. 8A is steeper than an inclination of the same portion of FIG. 7A. In this manner, the latest model of gas turbine has a characteristic in that the exhaust gas temperature rises or drops by large amounts with respect to an output change in the low output region.

The latest model of gas turbine is designed to use, for a heat exchanger of the heat recovery steam generator, a material that can endure high temperatures in comparison with the conventional gas turbine. Therefore, the maximum operating temperature T_{MAX} of the latest model of gas turbine is higher than the maximum operating temperature T_{MAX} of the conventional gas turbine. That is, T_{MAX} (engineering value) of FIG. 8A (and FIG. 8B, FIG. 8C) is higher than T_{MAX} (engineering value) of FIG. 7A (and FIG. 7B, FIG. 7C). Therefore, the second output value K (engineering value) of FIG. 8A and the other drawings is also a value that is different from the second output value K (engineering value) of FIG. 7A and the other drawings. However, in the present specification, same signs T_{MAX} and K are used through FIGS. 7A to 8C for the convenience of description.

FIG. 8B is a graph at the time when the atmospheric temperature is 30° C. In this case, the curve of the exhaust gas temperature characteristics shifts leftward in comparison with the case of 15° C. Therefore, when the gas turbine operates at the second output value K, the exhaust gas temperature becomes T_{MAX}+α3, (α3 is a positive value), which is higher than T_{MAX}. Note that, since the curve of the FIG. 8B is steeper than the curve of FIG. 7B, the deviation amount α3 is larger than the deviation amount α1.

FIG. 8C is a graph at the time when the atmospheric temperature is 0° C. In this case, the curve of the exhaust gas temperature characteristics shifts rightward in comparison with the case of 15° C. Therefore, when the gas turbine operates at the second output value K, the exhaust gas temperature becomes T_{MAX}−α4, (α4 is a positive value), which is lower than T_{MAX}. Note that, since the curve of the FIG. 8B is steeper than the curve of FIG. 7B, the temperature drop amount α4 is larger than the temperature drop amount α2.

In the latest model of gas turbine, the exhaust gas temperature deviates from T_{MAX} by α3 when the atmospheric temperature is 30° C. Therefore, with consideration given to the deviation amount α3, the second output value is set at a value K′, which is smaller than K, rather than K. The second output value K′ is a gas turbine output with which the exhaust gas temperature becomes the maximum operating temperature T_{MAX} when the atmospheric temperature is 30° C.

However, when the second output value K′ is adopted, a problem occurs when the atmospheric temperature is 0° C. Specifically, if the gas turbine operates at the second output value K′ when the atmospheric temperature is 0° C., the exhaust gas temperature becomes T_{MAX}−α5 (α5 is a positive value), which is lower than T_{MAX}−α4. In this case, since the curve of FIG. 8C is steep, the temperature drop amount α5 is a large value, which makes the exhaust gas temperature drop from T_{MAX} considerably. This means that if the latest model of gas turbine operates at the second output value K′ when the atmospheric temperature is 0° C., an effect of quickly increasing a main steam temperature cannot exert sufficiently, and shortening of the starting time of the plant cannot be expected.

As seen from the above, in the latest model of gas turbine having a steep curve of the exhaust gas temperature characteristics, when the first and second output values are applied to the gas turbine output, how to select the second output value becomes difficult due to the influence of the atmospheric temperature.

In one embodiment, a plant control apparatus is configured to control a power plant including a combustor configured to burn fuel with air to generate a combustion gas, a gas turbine configured to be driven by the combustion gas from the combustor, a heat recovery steam generator configured to use heat of an exhaust gas from the gas turbine to generate steam, and a steam turbine configured to be driven by the steam from the heat recovery steam generator. The plant control apparatus includes a gas turbine controller configured to control an output value of the gas turbine to a second output value that is larger than a first output value and depends on an atmospheric temperature and then control the output value of the gas turbine to the first output value. The plant control apparatus further includes a steam turbine controller configured to start up the steam turbine while the output value of the gas turbine is controlled to the first output value.

### First Embodiment

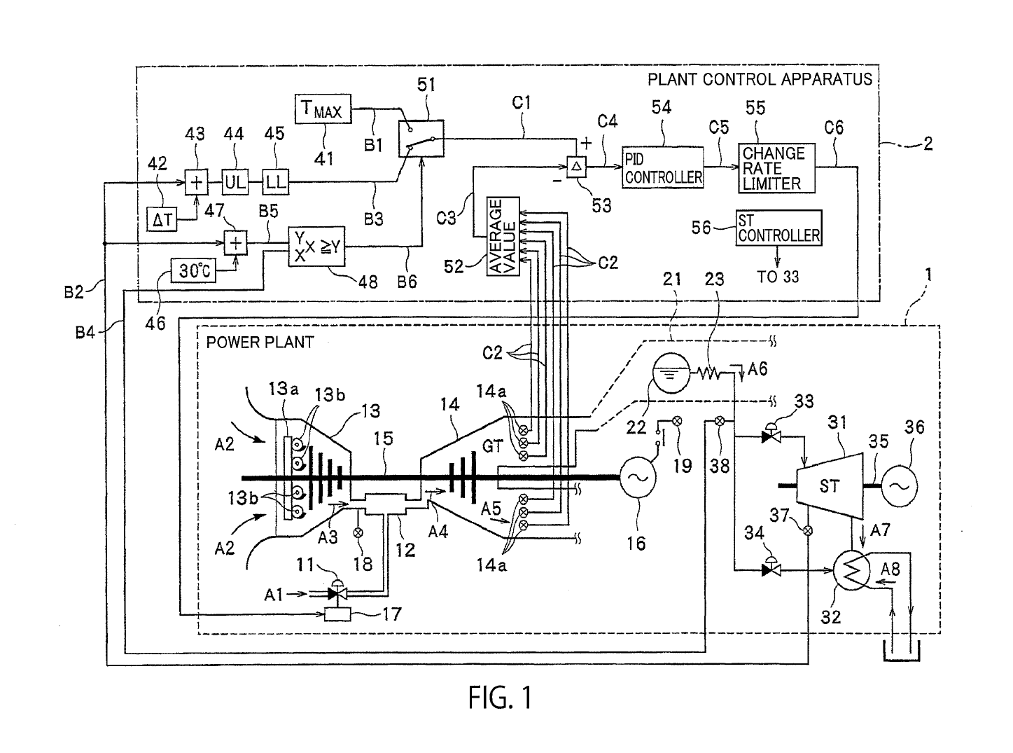

FIG. 1 is a schematic diagram illustrating a configuration of a power plant 1 in a first embodiment. The power plant 1 in the present embodiment includes a plant control apparatus 2 that controls the power plant 1. The power plant 1 in the present embodiment is a combined-cycle power plant.

The power plant 1 includes a fuel flow control valve 11, a combustor 12, a compressor 13, a gas turbine 14, a gas turbine (GT) rotating shaft 15, a GT electric power generator 16, a servo valve 17, a compressed air temperature sensor 18, an output sensor 19, a heat recovery steam generator 21, a drum 22, a superheater 23, a steam turbine 31, a condenser 32, a regulating valve 33, a bypass control valve 34, a steam turbine (ST) rotating shaft 35, a ST power generator 36, a metal temperature sensor 37, and a main steam temperature sensor 38. The compressor 13 includes an inlet 13a and a plurality of inlet guide vanes (IGVs) 13b. The gas turbine 14 includes a plurality of exhaust gas temperature sensors 14a.

The plant control apparatus 2 includes a setter 41, a setter 42, an adder 43, an upper limiter 44, a lower limiter 45, a setter 46, an adder 47, a comparator 48, a switcher 51, an average value operator 52, a subtractor 53, a proportional-integral-derivative (PID) controller 54, and a change rate limiter 55. These blocks control the servo valve 17 so as to function as a gas turbine (GT) controller that controls the operations of the gas turbine 14 and the GT electric power generator 16. The plant control apparatus 2 further includes a steam turbine (ST) controller 56 that controls the regulating valve 33 to control the operations of the steam turbine 31 and the ST power generator 36.

The fuel flow control valve 11 is provided in fuel piping. When the fuel flow control valve 11 is opened, fuel A1 is supplied from the fuel piping to the combustor 12. The compressor 13 includes the IGVs 13b provided at the inlet 13a. The compressor 13 introduces air A2 from the inlet 13a through the IGVs 13b to supply compressed air A3 to the combustor 12. The combustor 12 burns the fuel A1 with the compressed air A3 to generate a combustion gas A4 at high temperature and high pressure.

The gas turbine 14 is driven rotationally by the combustion gas A4 to rotate the GT rotating shaft 15. The GT electric power generator 16 is connected to the GT rotating shaft 15 and generates electric power by means of the rotation of the GT rotating shaft 15. An exhaust gas A5 discharged from the gas turbine 14 is delivered to the heat recovery steam generator 21. Each exhaust gas temperature sensor 14a detects the temperature of the exhaust gas A5 in the vicinity of the outlet of the gas turbine 14 and outputs the result of detecting the temperature to the plant control apparatus 2. The heat recovery steam generator 21 generates steam by means of the heat of the exhaust gas A5, which will be described later.

The combustor 12 according to the present embodiment is a low NO_{X} combustor, and the gas turbine 14 has the exhaust gas temperature characteristics illustrated in FIG. 8A to FIG. 8C. In this case, one combustor 12 is normally provided with a plurality of fuel flow control valves 11. For the convenience of illustration, FIG. 1 illustrates only one of the plurality of fuel flow control valves 11.

The servo valve 17 is used to adjust the degree of opening of the fuel flow control valve 11. The compressed air temperature sensor 18 detects the temperature of the compressed air A3 at the vicinity of the outlet of the compressor 13 and outputs the result of detecting the temperature to the plant control apparatus 2. The temperature of the compressed air A3 measured by the compressed air temperature sensor 18 is made higher than the atmospheric temperature in the vicinity of the inlet 13a of the compressor 13 through a compression process. The output sensor 19 detects the output of the gas turbine 14 and outputs the result of detecting the output to the plant control apparatus 2. The output of the gas turbine 14 is electricity output of the GT electric power generator 16 connected to the gas turbine 14. The output sensor 19 is provided in the GT electric power generator 16.

The drum 22 and the superheater 23 are provided in the heat recovery steam generator 21, constituting part of the heat recovery steam generator 21. Water in the drum 22 is delivered to an evaporator (not illustrated) and heated by the exhaust gas A5 in the evaporator to turn into saturated steam. The saturated steam is delivered to the superheater 23 and superheated by the exhaust gas A5 in the superheater 23 to turn into superheater steam A6. The superheater 23 is a heat exchanger that performs heat exchange between the exhaust gas A5 and the saturated steam. The superheater steam A6 generated by the heat recovery steam generator 21 is discharged to steam piping. Hereafter, this superheater steam A6 is referred to as main steam.

The steam piping is branched into main piping and bypass piping. The main piping is connected to the steam turbine 31, and the bypass piping is connected to the condenser 32. The regulating valve 33 is provided in the main piping. The bypass control valve 34 is provided in the bypass piping. When the regulating valve 33 is opened, main steam A6 in the main piping is supplied to the steam turbine 31. The steam turbine 31 is driven rotationally by the main steam A6 to rotate the ST rotating shaft 35. The ST power generator 36 is connected to the ST rotating shaft 35 and generates electric power by means of the rotation of the ST rotating shaft 35. Main steam A7 discharged from the steam turbine 31 is delivered to the condenser 32.

Meanwhile, when the bypass control valve 34 is opened, the main steam A6 in the bypass piping bypasses the steam turbine 31 and is delivered to the condenser 32. The condenser 32 cools the main steam A6 and main steam A7 using circulating water A8 to condense the main steams A6 and A7 into water. In the case where the circulating water A8 is seawater, the circulating water A8 discharged from the condenser 32 is returned to the sea.

The metal temperature sensor 37 detects the metal temperature of a first stage inner surface of the steam turbine 31 and outputs the result of detecting the temperature to the plant control apparatus 2. The main steam temperature sensor 38 detects the temperature of the main steam A6 at the vicinity of a main steam flow outlet of the heat recovery steam generator 21 and outputs the result of detecting the temperature to the plant control apparatus 2.

[Controlling Temperature of Exhaust Gas A5]

The temperature of the exhaust gas A5 can be controlled by adjusting the amount of supply of the fuel A1 or the flow rate of the air A2. Description will be made below in detail about the amount of supply of the fuel A1 and the flow rate of the air A2.

The amount of supply of the fuel A1 is controlled by controlling the degree of opening of the fuel flow control valve 11. The plant control apparatus 2 outputs a valve control command signal for controlling the degree of opening of the fuel flow control valve 11 to the servo valve 17, so as to adjust the amount of supply of the fuel A1. For example, when the amount of supply of the fuel A1 decreases, the temperature of the combustion gas A4 decreases, the output value of the gas turbine 14 decreases, and the temperature of the exhaust gas A5 decreases. On the other hand, when the amount of supply of the fuel A1 increases, the temperature of the combustion gas A4 increases, the output value of the gas turbine 14 increases, and the temperature of the exhaust gas A5 increases. As seen from the above, the plant control apparatus 2 can control the degree of opening of the fuel flow control valve 11, so as to control the output value of the gas turbine 14, and thereby can control the temperature of the exhaust gas A5.

The flow rate of the air A2 is adjusted by controlling the degree of opening of the IGVs 13b. As with the degree of opening of the fuel flow control valve 11, the degree of opening of the IGVs 13b is controlled by the plant control apparatus 2. The compressor 13 sucks the air A2 through the IGVs 13b and compresses the air A2 to generate the compressed air A3. For example, when the degree of opening of the IGVs 13b increases, the flow rate of the air A2 increases, and the flow rate of the compressed air A3 increases. At this point, the temperature of the compressed air A3 is made higher than the original temperature of the air A2 (substantially an atmospheric temperature) through a compression process, whereas very low as compared with the temperature of the combustion gas A4. As a result, when the degree of opening of the IGVs 13b increases, the influence of the compressed air A3 increases, the temperature of the combustion gas A4 decreases, and the temperature of the exhaust gas A5 decreases. On the other hand, when the degree of opening of the IGVs 13b decreases, the influence of the compressed air A3 decreases, the temperature of the combustion gas A4 increases, and the temperature of the exhaust gas A5 increases. As seen from the above, controlling the degree of opening of the IGVs 13b, the plant control apparatus 2 can control the temperature of the exhaust gas A5. In the case of intending to change the degree of opening of the IGVs 13b while keeping the amount of supply of the fuel A1 constant, the output value of the gas turbine 14 changes little.

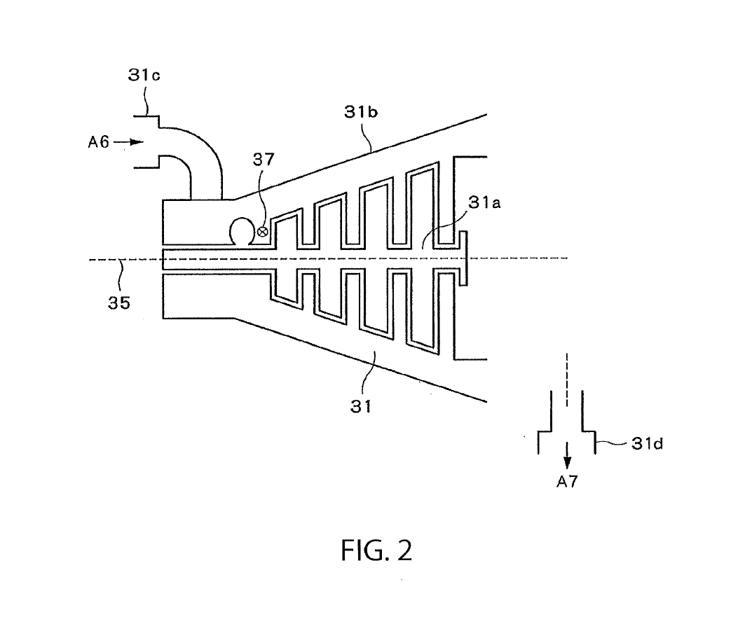

FIG. 2 is a cross-sectional view illustrating a structure of the steam turbine 31 in the first embodiment.

The steam turbine 31 includes a rotor 31a including a plurality of rotor blades, a stator 31b including a plurality of stator vanes, a steam flow inlet 31c, and a steam flow outlet 31d. The main steam A6 is introduced from the steam flow inlet 31c, passing through the steam turbine 31, and is discharged from the steam flow outlet 31d as the main steam A7.

FIG. 2 illustrates the position where the metal temperature sensor 37 is installed. The metal temperature sensor 37 is installed in the vicinity of the inner surface of a first stage stator vane in the steam turbine 31. Therefore, the metal temperature sensor 37 can detect the metal temperature of the inner surface of the first stage stator vane.

Referring to FIG. 1 again, the plant control apparatus 2 will be described below in detail.

The setter 41 holds a maximum operating temperature T_{MAX} as a setting B1 of the temperature of the exhaust gas A5 in normal time (hereafter, referred to as an exhaust gas temperature). The maximum operating temperature T_{MAX} is a maximum allowable exhaust gas temperature for the power plant 1, for example, a maximum allowable exhaust gas temperature for the heat recovery steam generator 21. The maximum operating temperature T_{MAX} is a constant that is specified based on the material and the like of the power plant 1. The maximum operating temperature T_{MAX} in the present embodiment is a maximum allowable exhaust gas temperature for the heat exchanger in the heat recovery steam generator 21 and is specified based on the material and the like of this heat exchanger.

The setter 42 holds a setting ΔT for the temperature difference on startup between the exhaust gas temperature and the metal temperature of the first stage inner surface in the steam turbine 31 (hereafter, referred to as a metal temperature). The setting ΔT is a constant as with the maximum operating temperature T_{MAX}.

The adder 43 acquires a measured value B2 of the metal temperature from the metal temperature sensor 37 and acquires the setting ΔT from the setter 42. Then, the adder 43 adds the setting ΔT to the measured value B2 of metal temperature and outputs a setting B2+ΔT of exhaust gas temperature.

The upper limiter 44 holds an upper limit value UL of the exhaust gas temperature and outputs either the setting B2+ΔT or the upper limit value UL, whichever is smaller. The lower limiter 45 holds a lower limit value LL of the exhaust gas temperature and outputs either the output of the upper limiter 44 or the lower limit value LL, whichever is larger. Therefore, the lower limiter 45 outputs a middle value of the setting B2+ΔT, the upper limit value UL, and the lower limit value LL, as a setting B3 of exhaust gas temperature. This means that the setting B2+ΔT of exhaust gas temperature is limited to a value between the upper limit value UL and the lower limit value LL.

The setter 46 holds a setting (30° C.) of temperature difference between the temperature of the main steam A6 (hereafter, referred to as a main steam temperature) and the metal temperature. This setting may be determined to be a negative constant rather than a positive constant.

The adder 47 acquires the measured value B2 of metal temperature from the metal temperature sensor 37 and acquires the setting of temperature difference from the setter 46. Then, the adder 47 adds the setting of temperature difference to the measured value B2 of metal temperature and outputs B2+30° C., which is a setting B5 of main steam temperature.

The comparator 48 acquires a measured value B4 of main steam temperature from the main steam temperature sensor 38 and acquires the setting B5 of main steam temperature from the adder 47. Then, the comparator 48 compares the measured value B4 of main steam temperature with the setting B5 and outputs a switching signal B6, which corresponds to the result of the comparison.

The switcher 51 acquires the setting B1 (=T_{MAX}) of exhaust gas temperature in normal time from the setter 41, acquires the setting B3 of exhaust gas temperature on startup from the lower limiter 45, and outputs a setting C1 for exhaust gas temperature in accordance with the switching signal B6 from the comparator 48.

The indication of the switching signal B6 changes according to whether or not a measured value B4(X) of main steam temperature increases to a setting B5(Y) and reaches the setting B5(Y) (X≧Y). Before the measured value B4 reaches the setting B5, the switcher 51 keeps the setting C1 to be the setting B1 of exhaust gas temperature in normal time. On the other hand, when the measured value B4 reaches the setting B5, the switcher 51 switches the setting C1 to the setting B3 for exhaust gas temperature on startup. The setting C1 is used as a setting (SV value) in PID control. Hereafter, the setting C1 will also be referred to as the SV value.

The average value operator 52 acquires measured values C2 of exhaust gas temperatures from the different exhaust gas temperature sensors 14a in the gas turbine 14. These exhaust gas temperature sensors 14a are installed along the circumference of a discharge unit of the gas turbine 14. The average value operator 52 calculates and outputs an average value C3 of these measured values C2. The average value C3 is used as a process value (PV value) in PID control. Hereafter, the average value C3 will also be referred to as the PV value.

The subtractor 53 acquires the SV value C1 of exhaust gas temperature from the switcher 51 and acquires the PV value C3 of exhaust gas temperature from the average value operator 52. Then, the subtractor 53 subtracts the SV value C1 from the PV value C3 and outputs a deviation C4 between the SV value C1 of exhaust gas temperature and the PV value C3 (Deviation C4=PV value C3−SV value C1).

The PID controller 54 acquires the deviation C4 from the subtractor 53 and performs PID control to bring the deviation C4 close to zero. An amount of manipulation (an MV value) C5 output from the PID controller 54 is the degree of opening of the fuel flow control valve 11. When the PID controller 54 changes the MV value C5, the degree of opening of the fuel flow control valve 11 changes, and the exhaust gas temperature changes. As a result, the PV value C3 of exhaust gas temperature changes so as to approach the SV value C1.

As seen from the above, the PID controller 54 performs feedback control to control the exhaust gas temperature. Specifically, the PID controller 54 calculates the MV value C5 based on the deviation C4 between the SV value C1 and the PV value C3 of exhaust gas temperature and controls the exhaust gas temperature through the control of the MV value C5.

However, the amount of supply of the fuel A1 cannot be increased or decreased at an extremely high change rate. For this reason, the MV value C5 is input into the change rate limiter 55 holding the upper limit value of a change rate for the amount of supply of the fuel A1. The lower limiter 55 outputs the MV value C5 that is limited so that the change rate for the amount of supply of the fuel A1 becomes equal to or smaller than the upper limit value, as a corrected MV value C6.

The plant control apparatus 2 outputs the MV value C6 to drive the servo valve 17, controlling the degree of opening of the fuel flow control valve 11 by means of hydraulic working of the servo valve 17. As a result, the degree of opening of the fuel flow control valve 11 changes in accordance with the MV value C6, and the PV value C3 of exhaust gas temperature changes so as to approach the SV value C1. In the present embodiment, the PID control of the exhaust gas temperature by the PID controller 54 is provided with a dead band so that pulsation of the output value of the gas turbine 14 is suppressed. The dead band will be described later in detail.

[Settings B1, B3 of Exhaust Gas Temperature]

Explanation will be made below about the difference between the setting B1 of exhaust gas temperature in normal time and the setting B3 of exhaust gas temperature on startup.

The setting B1 of exhaust gas temperature in normal time is used, for example, on startup of the power plant 1 until the main steam temperature satisfies a predetermined condition. Meanwhile, the setting B3 of exhaust gas temperature on startup is used, for example, on startup of the power plant 1 after the main steam temperature satisfies the predetermined condition.

On startup of the power plant 1, which is of the combined-cycle type, it is desired to increase exhaust gas temperature to facilitate the generation of the main steam A6. Therefore, the setting B1 from the setter 41 is desirably set so that the exhaust gas temperature reaches a relatively high temperature, and in the present embodiment, the setting B1 is set at the maximum operating temperature T_{MAX}. The maximum operating temperature T_{MAX} is, for example, 550° C.

Meanwhile, the setting B3 of exhaust gas temperature on startup is used to set the main steam temperature at a temperature suitable for the startup of the steam turbine 31. Specifically, when the measured value B5 of exhaust gas temperature reaches the setting B4, the setting C1 of exhaust gas temperature is switched from the setting B1 in normal time to the setting B3 on startup so as to bring the main steam temperature close to the metal temperature. The setting B3 is generally given as the sum of the measured value B2 of metal temperature and the setting ΔT for temperature difference (i.e., exhaust gas temperature=metal temperature+ΔT).

This configuration reduces a mismatch between the main steam temperature and the metal temperature. With this configuration, steam injection into the steam turbine 31 produces the main steam A6 with which a thermal stress occurring in the steam turbine 31 is low, which is preferable. For example, the setting ΔT is 30° C.

However, if the setting B3 of exhaust gas temperature has an excessively large or small value causes an inconvenience to the operation of the gas turbine 14 and the heat recovery steam generator 21. For this reason, the setting B3 is set by limiting the value of the metal temperature+ΔT to the value between the upper limit value UL and the lower limit value LL.

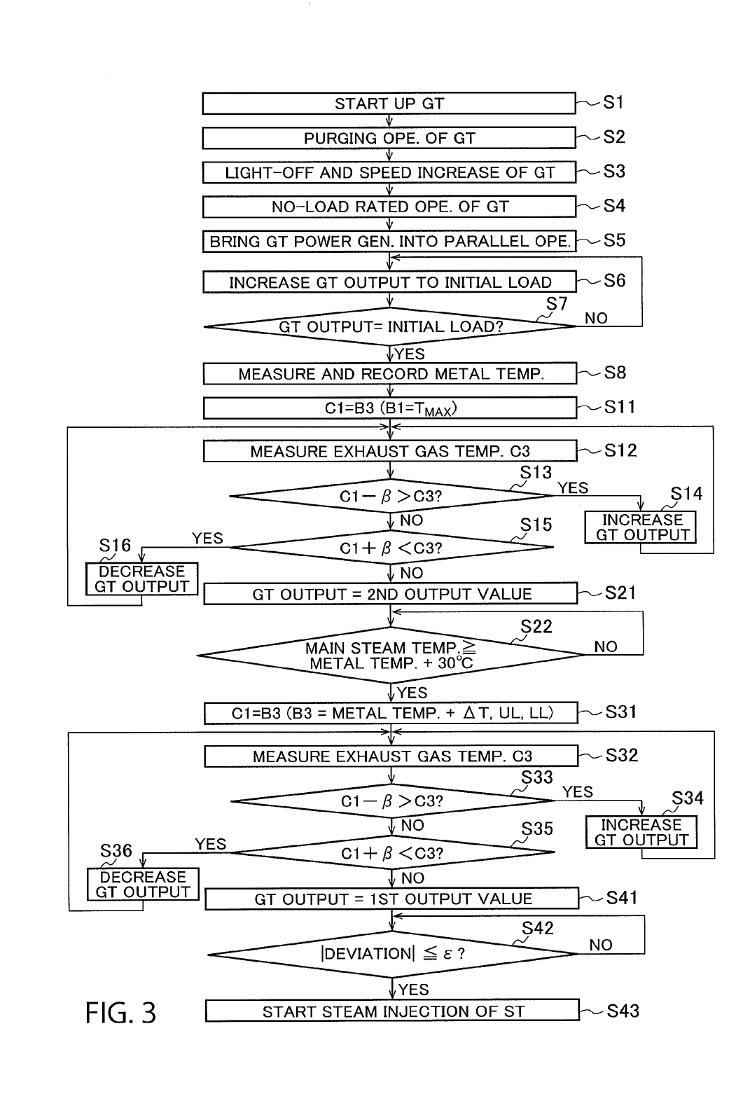

FIG. 3 is a flowchart illustrating a plant control method in the first embodiment. This plant control method is executed on startup of the power plant 1 by the plant control apparatus 2.

When the gas turbine 14 is started up (step S1), and the gas turbine 14 is subjected to purging operation (step S2). Next, light-off of the gas turbine 14 is carried out and the speed of the gas turbine 14 is increased (step S3), whereby the gas turbine 14 is brought into no-load rated operation (step S4).

Next, the GT electric power generator 13 is brought into parallel operation (step S5), and thereafter, in order to avoid the disturbance of reverse power immediately after the parallel operation, the plant control apparatus 2 immediately increases the output value of the gas turbine 14 (hereafter, referred to as a GT output value) to an initial load (steps S6 and S7). When the GT output value reaches the initial load, the plant control apparatus 2 acquires and stores the measured value B2 of metal temperature from the metal temperature sensor 37 (step S8).

Next, in order to promote a quick increase of the main steam temperature, the plant control apparatus 2 sets the setting (SV value) C1 of exhaust gas temperature at the setting B1 in normal time (=the maximum operating temperature T_{MAX}) (step S11).

Next, an actual exhaust gas temperature at the moment is measured (step S12). Specifically, measured values C2 of exhaust gas temperatures from the different exhaust gas temperature sensors 14a are acquired, and the average value (PV value) C3 of these measured value C2 is calculated. Next, a comparison is made between the SV value C1−β and the PV value C3 (step S13). β is a positive constant (e.g., 5° C.) for specifying an allowable deviation range of the exhaust gas temperature, and by using β, it is possible to provide the dead band in the PID control of the exhaust gas temperature by the PID controller 54. In the case of not providing the dead band, β is replaced with zero. If the SV value C1−β is higher than the PV value C3, the GT output value is increased (step S14), and the plant control returns to step S12. If the SV value C1−β is lower than the PV value C3, the plant control proceeds to step S15.

Next, a comparison is made between the SV value C1+β and the PV value C3 (step S15). If the SV value C1+β is lower than the PV value C3, the GT output value is decreased (step S16), and the plant control returns to step S12. If the SV value C1+β is higher than the PV value C3, the plant control returns to step S12 without changing the GT output value.

By repeating steps S12 to S16, the GT output value is controlled so that the PV value C3 is kept within a range of the SV value C1 (=T_{MAX})±β. This GT output value corresponds to the second output value in the present embodiment (step S21). To be exact, the second output value in the present embodiment is a GT output value with which the exhaust gas temperature can be kept at T_{MAX}. While the GT output value is kept at the second output value, the heat recovery steam generator 21 receives the exhaust gas A5 at the maximum operating temperature T_{MAX} so as to perform powerful heat recovery, whereby the main steam temperature is quickly increased.

In such a manner, in steps S12 to S16, the PV value C3 of exhaust gas temperature is controlled within a certain range, that is, the range of T_{MAX}±β (meanwhile, if β is zero, the PV value C3 is controlled to a certain value, that is, T_{MAX}). However, since the exhaust gas temperature characteristics is influenced by the atmospheric temperature, the GT output value to obtain the exhaust gas A5 within T_{MAX}±β changes in accordance with the atmospheric temperature. Therefore, the second output value in the present embodiment changes depending on the atmospheric temperature.

In other words, the GT output is increased so that the exhaust gas temperature depending on the atmospheric temperature is increased to T_{MAX}±β, and the GT output at the time when the exhaust gas temperature falls within the range of T_{MAX}±β is determined as the second output value. By such control, the second output value is not fixed but determined as a value that has a relation with the exhaust gas temperature and depends on the atmospheric temperature.

By this control, when the atmospheric temperature is high, exhaust gas at a high temperature can be generated even with a small GT output value, so that the second output value is a small value. On the other hand, when the atmospheric temperature is low, exhaust gas at a low temperature is generated even with a large GT output value, so that the second output value is a large value.

When the exhaust gas temperature is continuously adjusted to T_{MAX}, the main steam temperature rises to an extremely high temperature. If this main steam is used in the steam injection of the steam turbine 31, the steam turbine 31 suffers an excessively large thermal stress. Therefore, at an appropriate timing, the SV value C1 of exhaust gas temperature is switched from the setting B1 in normal time to the setting B3 on startup.

Specifically, the plant control apparatus 2 determines whether or not the measured value B4 of main steam temperature is equal to or larger than the setting B5 (step S22). The setting B5 is calculated by adding 30° C. to the measured value B2 of metal temperature (B5=B2+30° C.). This temperature of 30° C. is an example of the predetermined temperature.

Then, when the measured value B4 of main steam temperature increases to the setting B5, the SV value C1 of exhaust gas temperature is switched to the setting B3 on startup (step S31). The gas turbine 14 cannot operate at extremely high or low exhaust gas temperatures, and therefore the limits, the upper limit value UL and the lower limit value LL, are imposed on the setting B3. Specifically, the setting B3 is set at a middle value of B2+ΔT, UL, and LL.

Next, as in step S12, an actual exhaust gas temperature at the moment is measured (step S32).

Next, a comparison is made between the SV value C1−β and the PV value C3 (step S33). If the SV value C1−β is higher than the PV value C3, the GT output value is increased (step S34), and the plant control returns to step S32. If the SV value C1−β is lower than the PV value C3, the plant control proceeds to step S35.

Next, a comparison is made between the SV value C1+β and the PV value C3 (step S35). If the SV value C1+β is lower than the PV value C3, the GT output value is decreased (step S36), and the plant control returns to step S32. If the SV value C1+β is higher than the PV value C3, the plant control returns to step S32 without changing the GT output value.

By repeating steps S32 to S36, the GT output value is controlled so that the PV value C3 is kept within a range of the SV value C1 (=the metal temperature+ΔT)±β. This GT output value corresponds to the first output value in the present embodiment (step S41). To be exact, the first output value in the present embodiment is a GT output value with which the difference between the exhaust gas temperature and the metal temperature can be kept at ΔT.

In such a manner, in steps S32 to S36, the difference between the exhaust gas temperature and the metal temperature is controlled within a certain range, that is, the range of ΔT±β (meanwhile, if β is zero, the difference between the exhaust gas temperature and the metal temperature is controlled to a certain value, that is, ΔT).

Keeping the GT output value at the first output value while keeping the exhaust gas temperature at the setting B3 causes the main steam temperature to increase with time to asymptotically approach the metal temperature. Therefore, the plant control apparatus 2 acquires the measured value of the main steam temperature from the main steam temperature sensor 38 and calculates the deviation between the measured value of the main steam temperature and the measured value B2 of the metal temperature. Furthermore, the plant control apparatus 2 determines whether or not the absolute value of the deviation is equal to or less than ε (step S42).

Then, when the absolute value of the deviation becomes equal to or less than ε, the plant control apparatus 2 opens the regulating valve 33 to start the steam injection of the steam turbine 31 (step S43). In such a manner, while the GT output value is controlled to the first output value, the steam turbine 31 is started up. On the other hand, when the absolute value of the deviation becomes greater than ε, the plant control apparatus 2 puts itself on standby for starting the steam injection of the steam turbine 31. The processes of steps S42 and S43 are controlled by the ST controller 56.

Afterward, in the present method, the startup process of the power plant 1 is continued.

On the steam turbine 31, an increase of the speed of the steam turbine 31, the parallel operation of the ST power generator 36, an increase of the output of the steam turbine 31 to the initial load, initial load heat soak of the steam turbine 31, and a further increase of the output of the steam turbine 31 are performed in this order.

On the gas turbine 14, at a timing when the thermal stress in the steam turbine 31 is reduced to some extent to calm down, the SV value C1 of the exhaust gas temperature is switched again from the setting B3 on startup to the setting B1 in normal time. Then, an increase of the output of the gas turbine 14 from the initial load is started.

At the end of the startup process of the power plant 1, the output of the gas turbine 14 reaches a maximum output (base load) allowed under an atmospheric temperature condition on startup. From the exhaust gas A5 of the gas turbine 14 at the maximum output, the heat recovery steam generator 21 generates the main steam A6, which drives the steam turbine 31, causing the output thereof to reach a rated output.

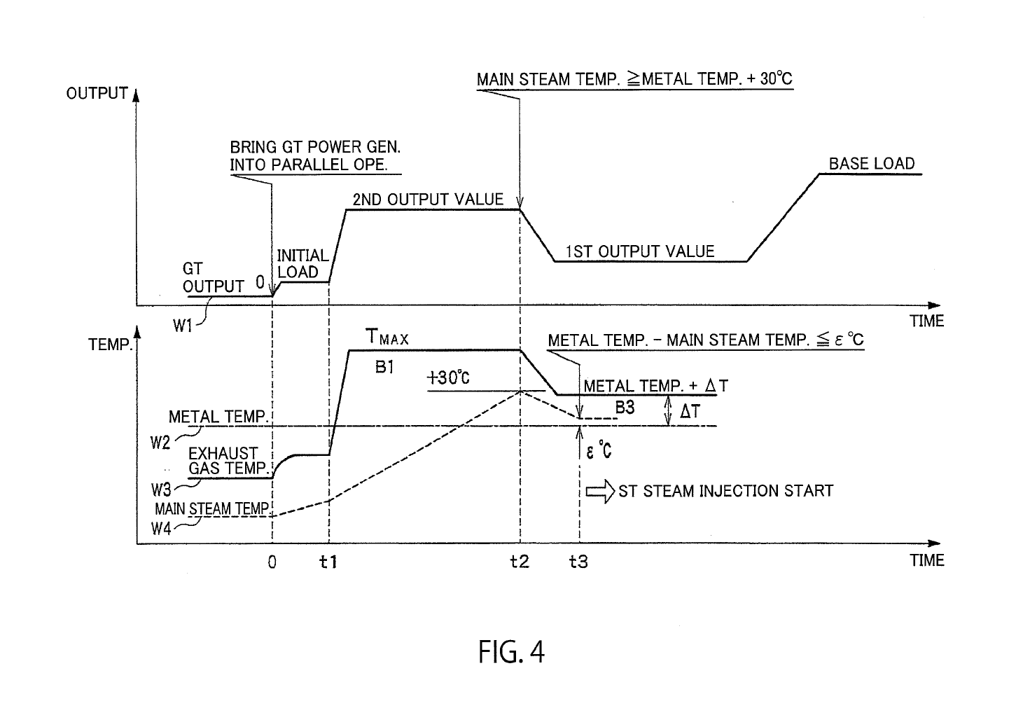

FIG. 4 is a graph for illustrating the plant control method in the first embodiment. The plant control method illustrated in FIG. 4 presents an operation example at the time when the atmospheric temperature is 0° C. and is executed according to the flow illustrated in FIG. 3.

When the GT electric power generator 16 is brought into the parallel operation, the GT output value starts to increase from zero toward the initial load (see a waveform W1). This also causes the exhaust gas temperature to start increasing (see a waveform W3). Furthermore, the main steam temperature also starts increasing (see a waveform W4).

At the time t1, the switcher 51 sets the SV value C1 of exhaust gas temperature at the setting B1 (=T_{MAX}) in normal time. Therefore, the exhaust gas temperature starts increasing toward the maximum operating temperature T_{MAX} at the time t1 (waveform W3). As a result, the GT output value increases to the second output value (waveform W1). Meanwhile, the main steam temperature keeps increasing (waveform W4).

Here, attention should be paid to differences between FIG. 4 and FIG. 8A to FIG. 8C.

In the latest model of gas turbine of FIG. 8A to FIG. 8C, the second output value is a constant that does not depend on the atmospheric temperature. However, since the use of the second output value K causes inconvenience in summer, the second output value K′ is used. The second output value K is a GT output value with which the exhaust gas temperature becomes T_{MAX} when the atmospheric temperature is 15° C., and the second output value K′ is a GT output value with which the exhaust gas temperature becomes T_{MAX} when the atmospheric temperature is 30° C. Therefore, if this latest model of gas turbine operates when the atmospheric temperature is 0° C., the exhaust gas temperature at the time when the GT output value is the second output value K′ becomes T_{MAX}−α5, which is much lower than T_{MAX}, so that the effect of quickly increasing the main steam temperature cannot exert sufficiently.

Meanwhile, in the gas turbine 14 of FIG. 4, the second output value is a variable that depends on the atmospheric temperature, specifically, a GT output value with which the exhaust gas temperature becomes T_{MAX}. Therefore, when the atmospheric temperature is 15° C., the second output value is K. When the atmospheric temperature is 30° C., the second output value is a value (=K′) that is smaller than K. When the atmospheric temperature is 0° C., the second output value is a value that is larger than K. Therefore, if the gas turbine 14 in the present embodiment operates, the exhaust gas temperature at the time when the GT output value is the second output value becomes T_{MAX} irrespective of the atmospheric temperature, so that the effect of quickly increasing the main steam temperature can exert sufficiently.

When the main steam temperature reaches the metal temperature+30° C. at the time t2 (waveforms W4, W2), the SV value C1 of exhaust gas temperature is switched to the setting B3 on startup. As a result, the exhaust gas temperature decreases to the setting B3 (=metal temperature+ΔT) (waveform W3), and the GT output value decreases to the first output value (waveform W1). In addition, the main steam temperature starts decreasing (waveform W4).

Afterward, the main steam temperature decreases, and the magnitude of the deviation between the main steam temperature and the metal temperature reaches c at the time t3 (waveforms W4, W2). Thereupon, the plant control apparatus 2 opens the regulating valve 33 at the time t3 to start the steam injection of the steam turbine 31.

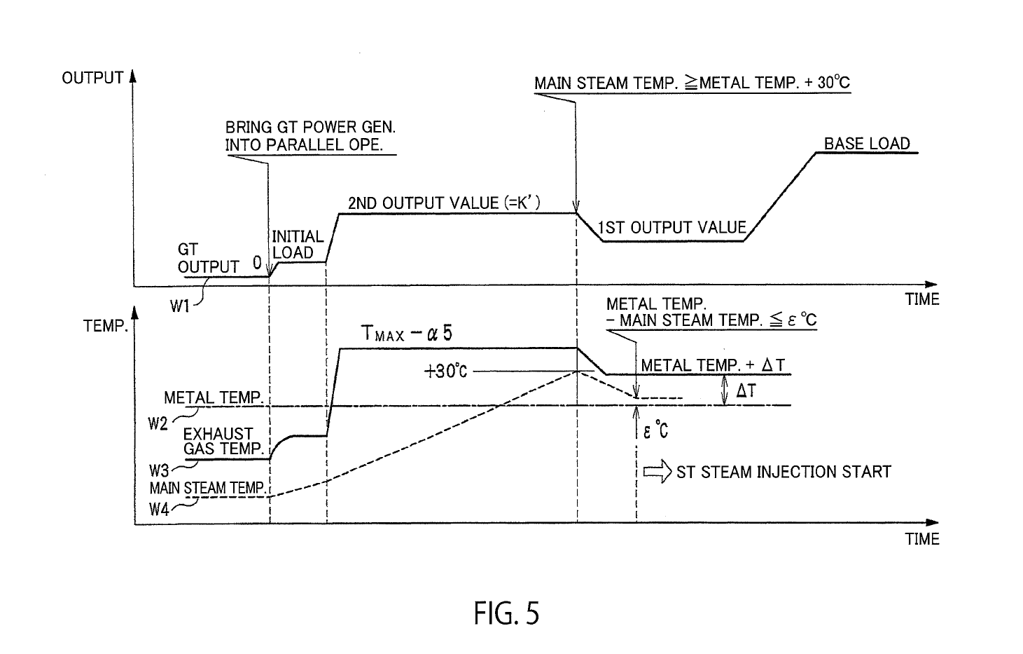

FIG. 5 is a graph for illustrating a plant control method in a comparative example of the first embodiment. The plant control method illustrated in FIG. 5 presents an operation example at the time when the atmospheric temperature is 0° C.

In the present comparative example, as with the latest model of gas turbine FIG. 8A to FIG. 8C, the second output value is determined to be a constant (=K′) that does not depend on the atmospheric temperature. Therefore, the GT output value starts increasing toward the second output value K′ at the time t1 (waveform W1), and the exhaust gas temperature rises to T_{MAX}−α5 (waveform W3).

The rise rate of the main steam temperature of FIG. 5 is lower than that of FIG. 4. As a result, the time t3 of FIG. 5 is delayed in comparison with the time t3 of FIG. 4, so that the main steam temperature cannot be increased quickly.

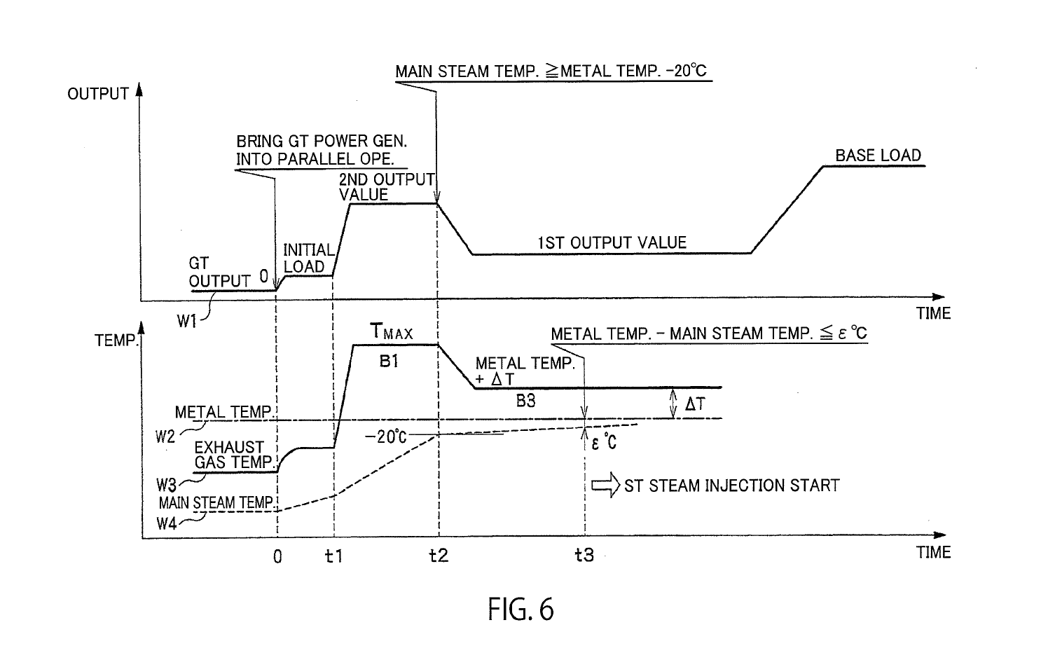

FIG. 6 is a graph for illustrating a plant control method in a modification of the first embodiment. The plant control method illustrated in FIG. 6 presents an operation example at the time when the atmospheric temperature is 0° C. and is executed according to the flow illustrated in FIG. 3.

FIG. 4 illustrates that the setting B5 of main steam temperature is given by adding 30° C. to the measured value B2 of metal temperature (B5=B2+30° C.). In contrast, FIG. 6 illustrates that the setting B5 of main steam temperature is given by subtracting 20° C. from the measured value B2 of metal temperature (B5=B2−20° C.). As seen from the above, the setting B5 of main steam temperature may be either higher or lower than the measured value B2 of metal temperature. These temperatures of +30° C. and −20° C. are examples of the predetermined temperature.

As seen from the above, according to the present embodiment, it is possible to achieve shortening of the starting time of the plant while absorbing the influence of the atmospheric temperature, which enables the pursuit of quick startup properties of the power plant 1 while allowing potential possessed by the power plant 1 to exert sufficiently.

As to the operation of the power plant 1, there are an idea of emphasizing the quick startup properties, where it is desirable that the power plant 1 can be quickly started up, and an idea of emphasizing power generation predictivity, where it is desirable that the amount of power generation by the power plant 1 can be accurately predicted. The present embodiment is considered to be effective in the case of adopting the former idea.

[Details on First Embodiment (1)]

The setter 41 in the present embodiment holds the maximum operating temperature T_{MAX} as the setting B1 of exhaust gas temperature. In the present embodiment, a maximum allowable exhaust gas temperature for the heat exchanger in the heat recovery steam generator 21 is defined as the maximum operating temperature T_{MAX}, and the maximum operating temperature T_{MAX} is specified based on the material and the like of the heat exchanger.

However, the maximum allowable exhaust gas temperature for the heat recovery steam generator 21 is not the maximum allowable temperature for the heat exchanger but may be a maximum allowable temperature for another part of the heat recovery steam generator 21. In this case, the latter maximum temperature may be used as the maximum operating temperature T_{MAX}.

Here, description will be made about the maximum operating temperature T_{MAX} for the heat exchanger of the heat recovery steam generator 21.

In a narrow sense, the heat exchanger of the heat recovery steam generator 21 refers to a tube (heat transfer tube) of the superheater 23 or a reheater (superheater for reheating), but in a broad sense, the heat exchanger also includes other components such as a header and connection piping. The following description on the heat exchanger also applies to these components.

In general, a GT output value with which the exhaust gas temperature is maximized is not 100% of a rated output value but within a middle output range. Within this output range, the startup process of the power plant 1 has proceeded to a considerable extent. Accordingly, the steam injection of the steam turbine 31 has already been done, and a lot of the main steam A6 has been generated from the heat exchanger of the heat recovery steam generator 21. Therefore, the main steam A6 exerts the effect of cooling the heat exchanger from the inside thereof.

In designing the heat exchanger, determinations are made on the size, material, thickness, and the like of the heat exchanger, from the viewpoints of an exhaust gas temperature, a main steam temperature, an initial stress, the physical strength of the heat exchanger, the economic efficiency of the heat exchanger, and the like. The temperature of the heat exchanger is settled and balanced at about the temperature of the main steam A6 that passes therethrough. A portion of the heat exchanger the temperature of which is the highest is generally an outer surface portion, which is in direct contact with the exhaust gas A5.

Then, the maximum operating temperature T_{MAX} of the heat exchanger is determined, with necessary and sufficient margin given in consideration of the exhaust gas temperature and the amount of a main steam flow. For example, for the heat recovery steam generator 21 used in combination with the gas turbine 14 in which the maximum temperature of the exhaust gas temperature is 600 to 650° C., it is preferable to set the maximum operating temperature T_{MAX} of the heat exchanger at 550 to 600° C. The cooling effect of the main steam A6 allows the operation of the power plant 1 at an exhaust gas temperature exceeding the maximum operating temperature T_{MAX} of the heat exchanger.

[Details on First Embodiment (2)]

In the above description, the maximum operating temperature T_{MAX} used as the setting B1 of exhaust gas temperature is determined to be the maximum allowable exhaust gas temperature for the heat recovery steam generator 21. However, the maximum allowable exhaust gas temperature for the power plant 1 is not the maximum allowable temperature for the heat recovery steam generator 21 but may be a maximum allowable temperature for another piece of equipment of the power plant 1. In this case, the latter maximum temperature may be used as the maximum operating temperature T_{MAX}.

Examples of such a piece of equipment include the condenser 32. In this case, the second output value may be specified as, for example, a maximum GT output value under which the degree of opening of the bypass control valve 34 is not fully open when all of the main steam A6 generated by the heat recovery steam generator 21 flows in the condenser 32 via the bypass control valve 34. In addition, the second output value may be specified as, for example, a maximum GT output value under which a difference in temperature of the circulating water A8 between the outlet and the inlet of the condenser 32 does not exceed a predetermined value when all of the main steam A6 generated by the heat recovery steam generator 21 flows in the condenser 32 via the bypass control valve 34.

As to the relation between the GT output value and the exhaust gas temperature, in a portion where the curve representing the exhaust gas temperature characteristics assumes a continuously increasing curve, the GT output value and the exhaust gas temperature shows a correlation with each other in a one-to-one relation (see FIG. 8A to FIG. 8C). Therefore, an exhaust gas temperature corresponding to the maximum GT output value is uniquely determined, which proves the existence of a maximum allowable exhaust gas temperature for the condenser 32.

As seen from the above, the plant control apparatus 2 in the present embodiment controls the GT output value to the second output value that is larger than first output value and depends on the atmospheric temperature before controlling the GT output value to the first output value. Then, the plant control apparatus 2 in the present embodiment starts up the steam turbine 31 while the GT output value is controlled to the first output value. Therefore, according to the present embodiment, it is possible to shorten the starting time of the combined-cycle power plant 1 including the gas turbine 14 and the steam turbine 31 while absorbing the influence of the atmospheric temperature.

While certain embodiments have been described, these embodiments have been presented by way of example only, and are not intended to limit the scope of the inventions. Indeed, the novel apparatuses, methods and plants described herein may be embodied in a variety of other forms; furthermore, various omissions, substitutions and changes in the form of the apparatuses, methods and plants described herein may be made without departing from the spirit of the inventions. The accompanying claims and their equivalents are intended to cover such forms or modifications as would fall within the scope and spirit of the inventions.

1. A plant control apparatus configured to control a power plant comprising:
a combustor configured to burn fuel with air to generate a combustion gas;
a gas turbine configured to be driven by the combustion gas from the combustor;
a heat recovery steam generator configured to use heat of an exhaust gas from the gas turbine to generate steam; and
a steam turbine configured to be driven by the steam from the heat recovery steam generator,
the plant control apparatus comprising:
a gas turbine controller configured to control an output value of the gas turbine to a second output value that is larger than a first output value and depends on an atmospheric temperature and then control the output value of the gas turbine to the first output value; and
a steam turbine controller configured to start up the steam turbine while the output value of the gas turbine is controlled to the first output value.

2. The apparatus of claim 1, wherein the gas turbine controller controls the output value of the gas turbine based on a temperature of the exhaust gas so as to control the output value of the gas turbine to the second output value that depends on the atmospheric temperature.

3. The apparatus of claim 2, wherein the gas turbine controller controls the temperature of the exhaust gas to a certain value or within a certain range so as to control the output value of the gas turbine to the second output value that depends on the atmospheric temperature.

4. The apparatus of claim 1, wherein the gas turbine controller controls the output value of the gas turbine based on the temperature of the exhaust gas and a metal temperature of the steam turbine so as to control the output value of the gas turbine to the first output value.

5. The apparatus of claim 4, wherein the gas turbine controller controls a difference between the temperature of the exhaust gas and the metal temperature to a certain value or within a certain range so as to control the output value of the gas turbine to the first output value.

6. The apparatus of claim 1, wherein the gas turbine controller changes the output value of the gas turbine to the first output value when a temperature of the steam reaches a predetermined temperature that depends on a metal temperature of the steam turbine.

7. The apparatus of claim 6, wherein the predetermined temperature is higher than the metal temperature.

8. The apparatus of claim 6, wherein the predetermined temperature is lower than the metal temperature.

9. The apparatus of claim 1, wherein the temperature of the exhaust gas when the output value of the gas turbine is the second output value is controlled to a maximum allowable temperature for the power plant.

10. The apparatus of claim 1, wherein the temperature of the exhaust gas when the output value of the gas turbine is the second output value is controlled to a maximum allowable temperature for the heat recovery steam generator.

11. The apparatus of claim 1, wherein the temperature of the exhaust gas when the output value of the gas turbine is the second output value is controlled to a maximum allowable temperature for a heat exchanger in the heat recovery steam generator.

12. A plant control method of controlling a power plant comprising:
a combustor configured to burn fuel with air to generate a combustion gas;
a gas turbine configured to be driven by the combustion gas from the combustor;
a heat recovery steam generator configured to use heat of an exhaust gas from the gas turbine to generate steam; and
a steam turbine configured to be driven by the steam from the heat recovery steam generator,
the plant control method comprising:
controlling an output value of the gas turbine to a second output value that is larger than a first output value and depends on an atmospheric temperature and then controlling the output value of the gas turbine to the first output value; and
starting up the steam turbine while the output value of the gas turbine is controlled to the first output value.

13. A power plant comprising:
a combustor configured to burn fuel with air to generate a combustion gas;
a gas turbine configured to be driven by the combustion gas from the combustor;
a heat recovery steam generator configured to use heat of an exhaust gas from the gas turbine to generate steam;
a steam turbine configured to be driven by the steam from the heat recovery steam generator;
a gas turbine controller configured to control an output value of the gas turbine to a second output value that is larger than a first output value and depends on an atmospheric temperature and then control the output value of the gas turbine to the first output value; and
a steam turbine controller configured to start up the steam turbine while the output value of the gas turbine is controlled to the first output value.
